(19) United States
(12) Patent Application Publication
(10) Pub. No.: US 2026/0246734 A1
(43) Pub. Date: Aug. 20, 2026

(54) SYSTEMS AND METHODS FOR NETWORK ROUTING OF DIFFERENT EVENTS FROM HETEROGENOUS DATASTREAMS TO DIFFERENT NETWORK COMPONENTS

(71) Applicant: Capital One Services, LLC, McLean, VA (US)

(72) Inventors: Samuel SHARPE, Somerville, MA (US); Peter TANSKI, Marlborough, MA (US)

(73) Assignee: Capital One Services, LLC, McLean, VA (US)

(21) Appl. No.: 19/054,750

(22) Filed: Feb. 14, 2025

(51) Int. Cl. H04L 45/00; H04L 45/02

(52) U.S. Cl. CPC H04L 45/54; H04L 45/02

(57) ABSTRACT

Systems and methods for improvements to network routing to different network components. As one example, systems and methods for a bifurcated routing system using datastream specific trainable embedding (e.g., an embedding table) to optimize resource allocation and model efficiency. For example, the system divides the network model into specialized components, or “experts,” each trained to handle specific types of inputs or tasks. A gating mechanism (e.g., a first router of the bifurcated routing system) dynamically determines which subset of components to activate for a given input, resulting in sparse activation.

### BACKGROUND

Routing decisions, whether in a computer network or an artificial intelligence model, are technically challenging due to the need to balance multiple competing factors in a dynamic and often unpredictable environment. In both contexts, routing must determine the optimal path or resource allocation based on incomplete or rapidly changing information. For example, in computer networks, routing algorithms must account for factors like bandwidth, latency, congestion, and reliability, while ensuring scalability across millions of devices. Similarly, in AI models, routing decisions involve selecting the most relevant pathways or experts based on input characteristics, which requires real-time computation and optimization without adding excessive overhead. The complexity arises from the need to handle diverse inputs, adapt to shifts in workload or data patterns, and maintain a consistent level of performance across different conditions.

Poor routing decisions can lead to significant problems, including inefficiency, bottlenecks, and degraded performance. In computer networks, suboptimal routing can cause congestion on certain paths while leaving others underutilized, leading to higher latency and packet loss, which degrade the quality of service. In AI models, poor routing may result in uneven utilization of components, overloading some experts while leaving others idle, reducing the overall efficiency of the model and potentially leading to slower inference or training. Furthermore, poor routing decisions in either context can propagate errors, amplifying their impact and causing cascading failures across the system. These issues highlight the importance of designing intelligent, adaptive routing mechanisms that can respond effectively to dynamic demands while minimizing computational and network overhead.

Processing heterogeneous datastreams further complicates routing decisions because such streams consist of data with diverse formats, rates, characteristics, and processing requirements. Unlike homogeneous streams, where the data can often be processed using a uniform pipeline, heterogeneous streams demand specialized handling for different types of data, such as text, images, sensor readings, or transactional records. This diversity introduces additional challenges in identifying the appropriate pathways, algorithms, or resources required to process each type of data efficiently. Routing must now account not only for computational load balancing but also for compatibility between data types and processing components, which can vary significantly in terms of latency, memory usage, and computational intensity. Moreover, the variability in arrival rates across different datastreams increases the complexity of maintaining system stability, as bursts or lulls in one stream can impact the availability of shared resources for others.

The problem is further exacerbated by the interdependencies that often exist between streams. For example, certain events in one stream may trigger processing in another, requiring coordination across streams to ensure coherent results. Inadequate or poorly designed routing decisions in this context can lead to resource contention, bottlenecks, or starvation of critical processes, undermining the overall system's throughput and reliability. Additionally, the need to dynamically adapt routing decisions in real-time, based on evolving patterns in heterogeneous data, adds a layer of computational overhead, making the design of efficient, scalable, and robust routing mechanisms significantly more complex. This highlights the necessity of intelligent, context-aware systems capable of managing heterogeneity while optimizing resource utilization and maintaining system performance.

### SUMMARY

Accordingly, systems and methods for improvements to network routing to different network components are described. As one example, systems and methods for improvements to network routing of different events from heterogenous datastreams to different network components are described. More specifically, systems and methods are described for a bifurcated routing system using datastream specific trainable embedding (e.g., an embedding table) to optimize resource allocation and model efficiency. For example, the system divides the network model into specialized components, or “experts,” each trained to handle specific types of inputs or tasks. A gating mechanism (e.g., a first router of the bifurcated routing system) dynamically determines which subset of components to activate for a given input, resulting in sparse activation. This specialization enables the system to handle diverse data distributions effectively, making it particularly useful for multitask learning and large-scale systems like language models and/or complex computer networks. However, novel gating mechanism also creates novel technical challenges such as increased model complexity and a potential imbalance in component utilization, which can lead to underutilized or overburdened experts.

In view of the potential for increased model complexity and a potential imbalance in component utilization, the system further adjusts the computational depth of a model dynamically based on the complexity of the input using the gating mechanism (e.g., a second router of the bifurcated routing system). For example, instead of solely activating specific components, the system may determine how many layers of a neural network are traversed during computation, enabling simpler inputs to use fewer layers while complex inputs use the full depth. This approach ensures efficient inference, as it reduces computational costs while maintaining accuracy for diverse input types. However, the use of the bifurcated routing system raises challenges in designing and training the controller mechanism that determines specified components and depth, as well as potential difficulties in ensuring stability and consistency across varying components and depth paths.

To overcome these technical hurdles, the system further uses a datastream specific trainable embedding to provide a unified, adaptive representation that captures the underlying characteristics of the data while simplifying the decision-making process for the bifurcated routing system. By embedding heterogeneous datastreams into a shared, dense, and trainable vector space, the embedding can directly handle the raw and unstructured inputs. The embedding may be tailored to encode not only the type of data but also its contextual and temporal patterns, which allows the routing mechanism to make informed decisions about which components and depths of the network to activate. This reduces the need for handcrafted feature engineering or rigid, rule-based decision-making systems, which can be brittle and fail to generalize well across diverse data scenarios.

The trainable embedding further contributes to stability and consistency across varying components and depth paths by serving as a common “language” for routing decisions. Since embeddings are learned during training, they inherently adapt to the model's objectives and the characteristics of the datastream, ensuring that the routing logic aligns with the task at hand. This helps mitigate issues like uneven utilization of network components, as the embeddings can reflect nuanced input characteristics, guiding data to the most appropriate paths. Furthermore, embeddings facilitate smooth integration across bifurcated systems by reducing mismatches between the routing logic and the specialized components, allowing for more seamless transitions between shallow and deep processing paths. By continuously adapting to the data and task, the trainable embedding reduces the computational overhead of dynamic routing by precomputing meaningful representations that make routing decisions more efficient. This synergy between embedding learning and routing optimization ultimately simplifies the design and training of bifurcated systems, ensuring that stability and performance are preserved across varying depths and components.

In some aspects, systems and methods for network routing from heterogenous datastreams to different network components are described. For example, the system may receive, from a first datastream of a plurality of datastreams, a first token for processing in a first network model, wherein the first model comprises a plurality of components, and wherein each component corresponds to a respective network node in the first network model. The system may retrieve a first embedding table, wherein the first embedding table comprises respective weights indicating respective probabilities of any potential token received from each of the plurality of datastreams being correctly directed to one or more of the plurality of components. The system may process the first token in a first router to determine a first probability for a first network node in the first network model being a correct destination node for the first token, wherein the first probability is based on the weights in the first embedding table. The system may filter the plurality of components based on whether each of the plurality of components is approved to receive potential tokens from the first datastream to generate a first subset of components. The system may determine that the first network node corresponds to one or more components in the first subset of components. The system may, in response to determining that the first network node corresponds to the one or more components in the first subset of components, process the first token in a second router to determine a second probability for the first network node in the first network model being the correct destination node for the first token. The system may direct the first token to the first network node based on the first probability and the second probability.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a bifurcated routing system for a network model, in accordance with one or more embodiments.

FIG. 2 shows an illustrative diagram for a datastream specific trainable embedding, in accordance with one or more embodiments.

FIG. 3 shows illustrative components for a system for network routing from heterogenous datastreams, in accordance with one or more embodiments.

FIG. 4 shows a flowchart of the steps involved in network routing from heterogenous datastreams, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

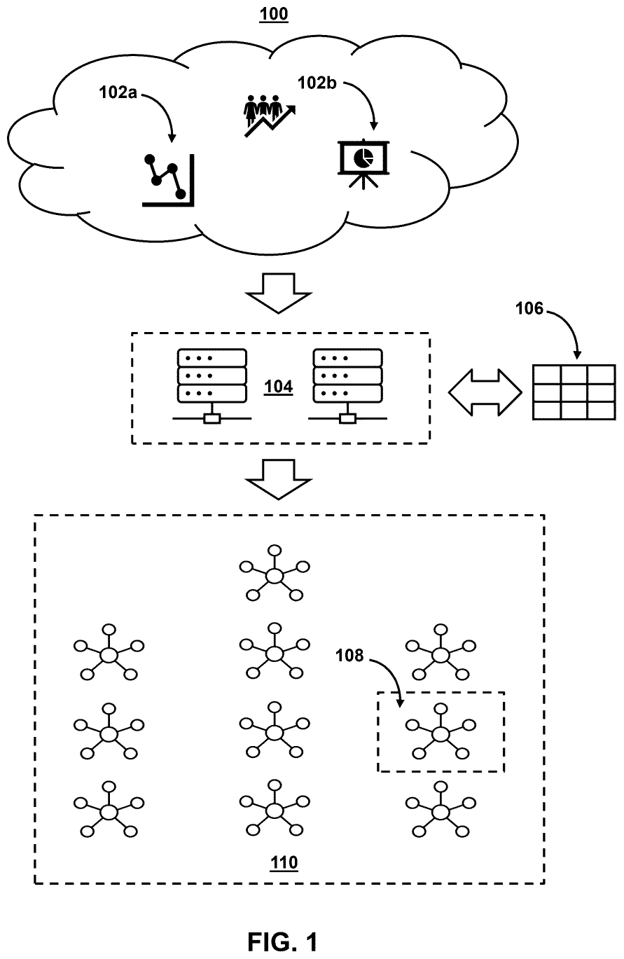

FIG. 1 shows an illustrative diagram for a bifurcated routing system for a network model, in accordance with one or more embodiments. For example, system 100 may be used for network routing of different events from heterogenous datastreams to different network components.

As shown in FIG. 1, system 100 may receive data from a plurality of datastreams (e.g., datastream 102a, datastream 102b, etc.). As referred to herein, “a datastream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment. In some embodiments, a datastream may comprise any content.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user. The content may be time-series data.

As described herein, “time-series data” may include a sequence of data points that occur in successive order over some period of time. In some embodiments, time-series data may be contrasted with cross-sectional data, which captures a point-in-time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time series analysis. For example, a time series analysis may be useful to see how a given asset, security, or economic variable changes over time. It can also be used to examine how the changes associated with the chosen data point compare to shifts in other variables over the same time period. For example, with regards to retail loss, the system may receive time series data for the various sub-segments indicating daily values for theft, product returns, etc.

System 100 may process the plurality of datastreams using bifurcated routing system 104. For example, bifurcated routing system 104 may comprise a first router and a second router used to route tokens based on events in the plurality of datastreams to different destination nodes in the network model 110. In some embodiments, bifurcated routing system 104 is a multi-level routing mechanism designed to process a plurality of datastreams by sequentially or hierarchically directing tokens (e.g., events, packets, or inputs) from these streams to appropriate destination nodes within a network model, such as network model 110. Bifurcated routing system 104 comprises two or more routers that work in tandem to make progressively granular routing decisions. The first router may operate at a coarse level, using high-level features or characteristics of the datastream to assign tokens to broader categories or initial processing paths. For example, it may determine which general component or region of the network model should handle a token based on its source datastream or type (e.g., image, text, or sensor data). The second router then operates at a finer level, using more detailed or contextual information to assign the token to a specific node, expert, or layer within the pre-selected path.

Bifurcated routing system 104 uses embedding table 106 as a foundational component to make informed and adaptive routing decisions for processing tokens from a plurality of datastreams. Embedding table 106 encodes the relationships between the characteristics of different datastreams and the potential destination nodes within the network model. Each datastream or token is represented as a dense, trainable vector in the embedding table, capturing its semantic, contextual, or structural features. When a token arrives, the system retrieves its corresponding embedding from the table and uses it as input to the routers in the bifurcated routing system.

The first router uses the token's embedding to make a high-level decision, determining the broad category or initial pathway for the token. For example, the embedding might indicate that a token from a particular datastream is best suited for processing in a text analysis module or an image processing pipeline. This decision is often probabilistic, with the router calculating a distribution over possible pathways based on the embeddings. These probabilities reflect the likelihood of achieving the best performance or efficiency for the given token.

After the first router assigns a general pathway, the second router refines this decision using more specific features derived from the embedding and additional context from the token itself or the system's state. The second router uses these refined embeddings to select a specific destination node, such as a particular neural network layer, expert module, or computational resource within the chosen pathway. This hierarchical decision-making process allows the system to balance efficiency and precision, leveraging the embeddings to guide tokens toward optimal routes through the network model.

By using embedding table 106, bifurcated routing system 104 ensures that routing decisions are both data-driven and dynamically adaptable. The embedding table is trained during system optimization to align with routing objectives, such as minimizing latency, maximizing accuracy, or balancing workloads. Over time, the embeddings capture increasingly nuanced relationships between datastreams and components, enabling the routing system to generalize across diverse inputs and adapt to evolving data patterns. This approach allows bifurcated routing system 104 to process heterogeneous datastreams effectively, ensuring that tokens are directed to the most appropriate components of the network model with minimal computational overhead.

This design is particularly advantageous for handling complex, heterogeneous datastreams, as it allows the system to efficiently divide labor across different routers and leverage their specific strengths. The first router can be optimized for speed and scalability, making quick decisions based on global patterns or embeddings of the datastreams, while the second router can focus on accuracy and specialization, making decisions based on fine-grained features or dynamically learned relationships. The bifurcated structure reduces the computational burden on any single routing mechanism and improves the overall system's ability to adapt to diverse and dynamic inputs.

For instance, in system 100, the bifurcated routing system 104 processes tokens from various datastreams by first consulting an embedding table or feature extractor to encode the input data. The first router might use these embeddings to assign tokens to high-level processing paths or subsystems in network model 110, such as a natural language processing pipeline for text data or a convolutional pipeline for images. The second router then refines this decision by directing the token to a specific node or expert within the selected subsystem, such as a specific layer of a neural network, a specialized processor, or an expert trained for a particular task. This hierarchical approach enables the system to process multimodal datastreams effectively, balancing the trade-offs between efficiency, specialization, and adaptiveness to changing data distributions.

In some embodiments, bifurcated routing system 104 may employ a hierarchical approach where the first router and the second router work together to route tokens efficiently and accurately based on the embeddings of the datastreams. The first router may be a function of the datastream embeddings, which encode the characteristics and relationships of each datastream with the network components. For each incoming token, the first router computes a probability distribution over all possible components in the network model, representing the likelihood of successfully processing the token at each component. This step may consider the global context and high-level features of the datastream, enabling the system to broadly classify the token and assign it to a subset of components that are compatible with its type or content.

Once the first router generates these routing probabilities, the second router refines the decision by restricting the selection to only those components that explicitly accept the token's corresponding datastream. This restriction ensures that tokens are routed only to components capable of handling their specific data type or processing requirements, preventing misallocations and inefficiencies. The second router then determines the exact routing path within the allowed subset, taking into account more granular features, such as the current state of the system, the workload on each component, and additional contextual details about the token.

For example, the first router might determine that a token from a text datastream is highly likely to require processing in a natural language processing pipeline. The second router would then select a specific expert module or layer within that pipeline, such as one trained for sentiment analysis or translation, based on the token's additional attributes or task requirements. This hierarchical routing mechanism ensures that tokens are first broadly categorized and then directed to the most appropriate and specialized processing units, optimizing both the efficiency and accuracy of the system.

By combining these two stages, the bifurcated routing system leverages datastream embeddings to handle complex, multimodal inputs dynamically while maintaining strict constraints on compatibility and specialization. This approach balances computational efficiency with the need for precision in routing, making it well-suited for processing heterogeneous datastreams in large, adaptive network models.

System 100 may then select a specific destination node (e.g., destination node 108) of network model 110. For example, system 100 may select a specific destination node, such as destination node 108 in network model 110, through a multi-stage routing process that integrates datastream embeddings and a bifurcated routing system to make efficient and precise decisions. When a token from a datastream is received, it is first encoded into a dense, trainable embedding using an embedding table. This embedding captures the key characteristics and contextual information of the token, enabling downstream components to use this representation for informed decision-making.

The first router in the bifurcated routing system evaluates the token's embedding and calculates probabilities over the broader set of components within network model 110. This initial routing decision serves to identify a subset of compatible components or pathways that are most likely to process the token effectively. The probabilities computed by the first router are based on global features of the token, such as its datastream type or high-level patterns encoded in the embedding.

Once this subset of components is determined, the second router refines the decision by narrowing the focus to specific nodes within the pre-selected pathway. Using both the token embedding and additional contextual information, the second router evaluates which destination node within the subset is best suited to handle the token's processing requirements. This decision takes into account factors such as the node's specialization, current workload, and the token's specific attributes or task requirements. The second router ensures that the routing probabilities are restricted to nodes capable of accepting the token's datastream, preventing misrouting and optimizing resource allocation.

For example, if the token represents a piece of text, the first router might assign it to a natural language processing module, and the second router would then direct it to a specific layer or expert node within that module, such as one trained for named entity recognition or sentiment analysis. By progressively refining the routing decisions, system 100 ensures that tokens are sent to the most appropriate destination node, balancing the need for accuracy, efficiency, and scalability across the entire network model.

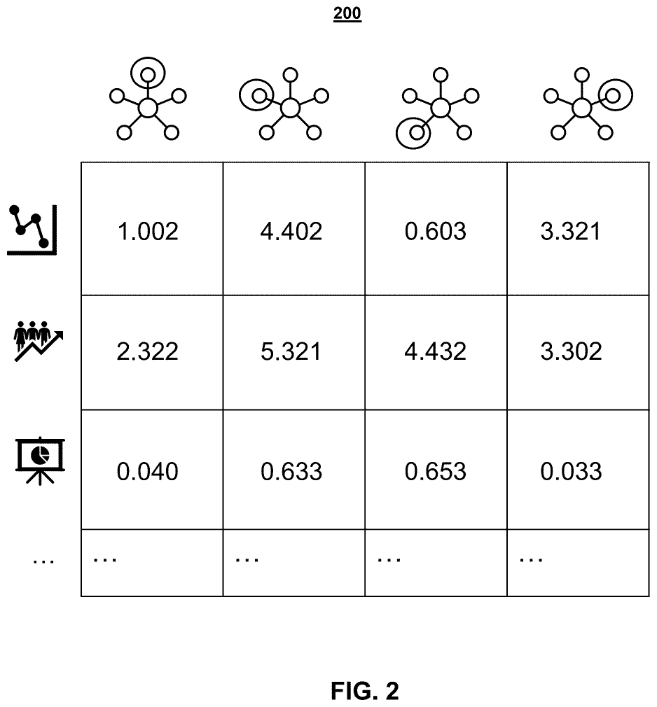

FIG. 2 shows an illustrative diagram for a datastream specific trainable embedding, in accordance with one or more embodiments. For example, the datastream specific trainable embedding may be captured in an embedding table.

As described herein, an embedding table may be a data structure used in machine learning, particularly in deep learning, to store dense vector representations (embeddings) of discrete entities, such as words, items, or categories. As shown in FIG. 2, embedding table 200 may be a two-dimensional matrix where each row corresponds to an entity, and each column represents a dimension in the embedding space. The purpose of an embedding table is to map high-dimensional or sparse inputs, such as one-hot encoded vectors, into lower-dimensional dense vectors that capture semantic or contextual relationships between entities. For example, in natural language processing, words with similar meanings are often mapped to embedding vectors that are close together in this learned vector space. The embedding table is either initialized randomly or preloaded with pre-trained embeddings, such as GloVe or Word2Vec, and is subsequently fine-tuned during training to optimize for the specific task. By providing a compact, trainable representation of discrete inputs, embedding tables enable models to generalize better, reduce computational complexity, and efficiently capture patterns and relationships in the data. They are foundational to a wide range of applications, from language modeling and recommendation systems to graph learning and categorical data encoding.

A system implements an embedding table, such as embedding table 200, as a 2D matrix where each row represents a unique datastream (e.g., from a plurality of multimodal datastreams), and each column represents a specific component or network node in the system. Each cell in the matrix contains embedding values that encode the relationship between a given datastream and a specific component, effectively capturing the compatibility or relevance of routing a particular token from that datastream to the component. This embedding table serves as a trainable layer that dynamically maps the incoming data to a lower-dimensional space, enabling efficient and informed routing decisions across the network.

The weights, or embedding values, in embedding table 200 are determined through a training process that aligns the embeddings with the system's routing objectives, such as minimizing latency, optimizing accuracy, or ensuring load balancing. During training, the system uses input-output pairs where the datastreams and tokens are the inputs, and the optimal routing decisions (target components or nodes) are the outputs. A probabilistic model, such as a neural network, uses the embeddings to predict routing probabilities for each component. These predictions are then compared against the ground truth, and the system computes a loss function, such as cross-entropy loss, to measure the mismatch between the predicted and actual routing decisions. Backpropagation adjusts the embedding values iteratively to minimize this loss, effectively encoding the learned relationships between datastreams and components in the embedding table.

By training on diverse data and scenarios, the system fine-tunes the embeddings to generalize across varying input distributions and contexts, enabling adaptive routing for multimodal datastreams. The resulting embedding table not only captures the distinct characteristics of each datastream and component but also reflects the likelihood of successful processing for a given input-component pair. This process ensures that the embeddings are optimized for both accuracy and efficiency, allowing the system to make precise, real-time routing decisions in complex, heterogeneous environments.

For example, embedding table 200 can be trained to include weights that indicate the respective probabilities of tokens from various datastreams being correctly routed to specific components by leveraging supervised or reinforcement learning techniques that align the embeddings with routing objectives. During training, each token from a datastream is associated with a target component or processing path that achieves the desired outcome, such as minimizing latency, maximizing accuracy, or balancing computational loads. The embedding table assigns a dense, trainable vector to each datastream or token, and these vectors are updated through backpropagation during training to encode not only the characteristics of the datastream but also the contextual information required for optimal routing decisions.

To empower a first router or bifurcated routing system, the embeddings from the table are used as input features for a probabilistic model, such as a neural network or softmax layer, which outputs a distribution over the available components. This probabilistic routing model is trained to maximize the likelihood of correctly directing tokens to their target components based on feedback from the system's performance. For example, if a token from a specific datastream consistently achieves better results when routed to a particular component, the weights in the embedding table are adjusted to increase the probability of that routing decision. Over time, the embeddings become specialized, capturing patterns and relationships within the datastreams that align with optimal routing paths.

The embedding table thus serves as a bridge between raw datastream inputs and routing logic, encoding rich information that simplifies the decision-making process. By training the embeddings to reflect routing probabilities, the system dynamically adapts to shifts in input distributions or task requirements, maintaining efficiency and performance. This approach is particularly effective in heterogeneous environments, where the embedding table enables a unified mechanism for learning routing strategies across diverse datastreams and components, ensuring that the first router or bifurcated system can operate efficiently and accurately in real time.

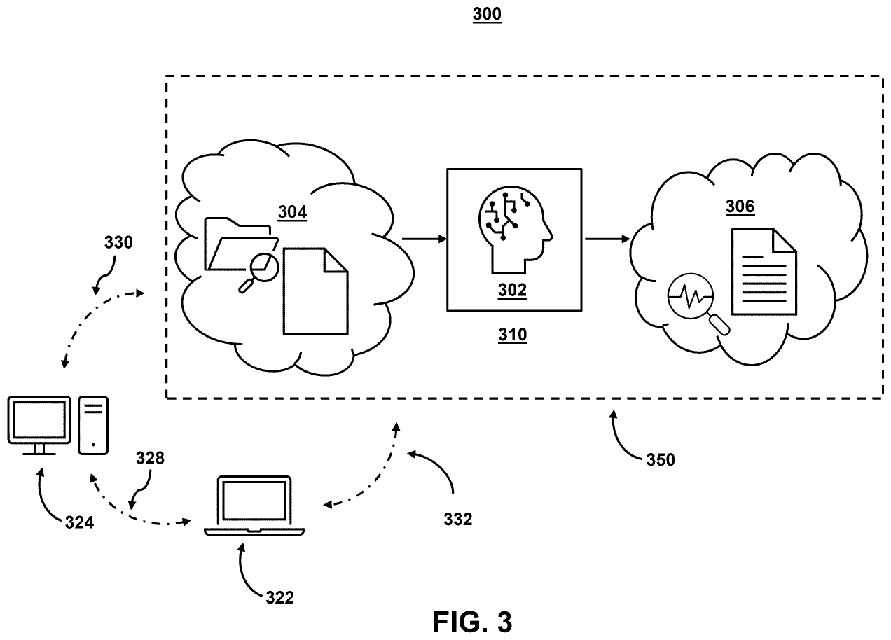

FIG. 3 shows illustrative components for a system for network routing from heterogenous datastreams, in accordance with one or more embodiments. For example, FIG. 3 may show illustrative components for network routing of different events from heterogenous datastreams to different network components. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a network node).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a network node).

In some embodiments, the model (e.g., model 302) may automatically perform actions based on outputs 306. In some embodiments, the model (e.g., model 302) may not perform any actions. The output of the model (e.g., model 302) may be used for network routing of different events from heterogenous datastreams to different network components.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

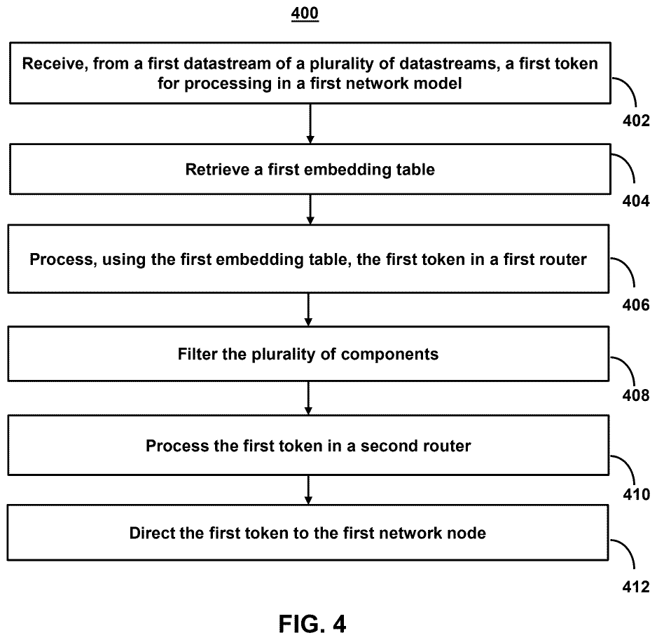

FIG. 4 shows a flowchart of the steps involved in network routing from heterogenous datastreams, in accordance with one or more embodiments. For example, the system may use process 400 (e.g., as implemented on one or more system components described above) for network routing of different events from heterogenous datastreams to different network components.

At step 402, process 400 (e.g., using one or more components described above) receives, from a first datastream of a plurality of datastreams, a first token for processing in a first network model. For example, the system may receive, from a first datastream of a plurality of datastreams, a first token for processing in a first network model, wherein the first network model comprises a plurality of components, and wherein each component corresponds to a respective network node in the first network model. For example, the system may receive a first token from a first datastream of a plurality of datastreams by continuously monitoring the incoming streams and leveraging a data ingestion pipeline tailored to handle the heterogeneity and real-time nature of the datastreams. When the token is received, it is preprocessed to ensure compatibility with the system's routing and processing mechanisms. This preprocessing step may involve operations such as normalization, feature extraction, or transformation into a standardized format that the network model can interpret. Each datastream is associated with a unique identifier or metadata, allowing the system to recognize that the token belongs to the first datastream. The first network model, comprising a plurality of components corresponding to respective network nodes, is structured to handle diverse inputs. Upon receiving the token, the system consults an embedding table or a feature extractor to generate a dense representation of the token, capturing its characteristics and contextual relevance. This embedding serves as the input for a bifurcated routing system or similar mechanism that determines the optimal pathway within the network model.

In some embodiments, the system may receive the first token by receiving a first event for processing in the first network model and generating the first token based on the first event by grouping sequences of multimodal inputs in the first event. For example, the system receives the first token by first processing a first event that arrives for handling in the first network model. The first event may consist of raw data from one or more multimodal inputs, such as text, images, audio, or sensor readings, grouped together to represent a single meaningful occurrence. Upon receiving the event, the system applies a preprocessing pipeline that organizes and aligns the multimodal data into a structured format. This may involve parsing the event data, synchronizing timestamps, or extracting key features from each modality to ensure consistency and relevance across the inputs. The system then groups sequences of related multimodal inputs within the event to create a cohesive representation. This grouping step involves analyzing temporal, contextual, or semantic relationships between the inputs to identify patterns or dependencies that link them as part of the same event. For example, in a monitoring system, a temperature spike and a related pressure alert may be grouped as part of a single event, or in a multimedia application, audio and video streams may be synchronized and grouped to represent a recorded segment. Once the inputs are grouped, the system processes them to generate the first token, which serves as an abstract, compact representation of the event. This token encapsulates the essential features and relationships derived from the multimodal data, often in the form of a dense embedding or a structured object. The token generation step may include feature extraction, dimensionality reduction, or transformation using machine learning models, ensuring that the token is optimized for routing and processing in the first network model. By converting the event into a token, the system enables efficient and standardized handling of diverse multimodal inputs, facilitating their integration into the network for downstream tasks. This token is then passed to the routing system for further processing and decision-making.

In some embodiments, the system may receive the first token by receiving a first event for processing in the first network model, determining an event type for the first event, and generating the first token based on the event type. A system receives the first token by processing a first event that arrives for handling in the first network model. Upon receiving the event, the system begins by analyzing its content and associated metadata to determine its event type, which categorizes the event based on predefined criteria or learned patterns. The determination of the event type may involve evaluating key attributes of the event, such as its source, structure, or content, and mapping these attributes to a specific type using classification models, rules, or embeddings. For instance, an event could be categorized as a “sensor anomaly,” “user interaction,” or “transaction alert” based on its characteristics. Once the event type is identified, the system uses this information to generate the first token, which serves as a compact, standardized representation of the event. The token encapsulates critical information about the event, including its type and any relevant features, such as numerical measurements, semantic content, or contextual details. This transformation may involve extracting features from the raw event data, normalizing them, and encoding them into a dense vector or other structured format tailored for efficient processing in the network model. By incorporating the event type into the token, the system ensures that the downstream routing and processing mechanisms are informed by the nature of the event, enabling more precise and context-aware decision-making. For example, tokens derived from different event types can be routed to specialized components in the network model that are optimized to handle their specific processing requirements. This process of event-type-based token generation allows the system to integrate diverse inputs seamlessly into the first network model while maintaining high efficiency and adaptability.

In some embodiments, the system may receive the first token by receiving a first event for processing in the first network model, determining a text string in the first event, and generating the first token based on applying parts-of-speech tagging to the text string. For example, the system may receive the first token by processing a first event that contains a text string and using natural language processing (NLP) techniques to generate the token. Upon receiving the event, the system identifies the text string within the event data, which may involve parsing structured or unstructured input to isolate relevant textual content. Once the text string is extracted, the system applies parts-of-speech (POS) tagging, a linguistic analysis technique that assigns grammatical categories, such as nouns, verbs, adjectives, and adverbs, to each word in the text. POS tagging helps the system understand the syntactic structure and semantic roles of words in the string. Using the tagged output, the system generates the first token by encoding the linguistic and contextual information derived from the text. This process may involve grouping words based on their POS tags, identifying key phrases or entities, and creating a compact representation of the text string that emphasizes its most significant features. For instance, the token may include embeddings for specific nouns and verbs that reflect the event's primary subjects and actions, or it might capture syntactic patterns that characterize the text. The token generated from this process is designed to convey the essential information in the text string while enabling efficient and accurate routing and processing in the first network model. By leveraging POS tagging, the system can extract meaningful insights from the text, ensuring that the token is optimized for tasks such as classification, information retrieval, or downstream language understanding. This approach allows the system to handle text-rich events effectively, converting raw linguistic data into structured tokens suitable for advanced processing.

In some embodiments, the system may receive the first token by receiving a first event sequence in the first datastream, detecting a first pattern in the first event sequence, determining a first event in the first event sequence based on the first pattern, and generating the first token based on first event. For example, the system may receive the first token by processing a first event sequence in the first datastream and applying pattern detection techniques to identify significant events. When the first event sequence is received, the system analyzes the sequence to detect recurring or predefined patterns that indicate the presence of meaningful events. These patterns can be temporal, statistical, or structural, such as specific sequences of data values, anomalous trends, or characteristic signal shapes. The system uses algorithms like rule-based pattern matching, machine learning models, or dynamic thresholding to detect the first pattern in the event sequence. Upon detecting the first pattern, the system determines the first event in the sequence that corresponds to this pattern. This determination involves isolating the portion of the sequence where the pattern occurs and extracting relevant features or signals that characterize the event. For example, if the sequence represents sensor data, the system might identify a spike or an anomaly as the first event. Similarly, in a text stream, the system could recognize a specific keyword sequence or phrase as the event. Once the first event is identified, the system generates the first token by encoding the event's salient features into a compact, structured representation. This token captures the essence of the event, such as its type, key attributes, and contextual metadata, ensuring that it can be efficiently routed and processed in the first network model. By basing the token generation on detected patterns, the system ensures that it focuses on significant events, filtering out noise and irrelevant data from the sequence. This approach enables the system to process complex event sequences dynamically, converting meaningful patterns into actionable tokens optimized for downstream tasks.

At step 404, process 400 (e.g., using one or more components described above) retrieves a first embedding table. For example, the system may retrieve a first embedding table, wherein the first embedding table comprises respective weights indicating respective probabilities of any potential token received from each of the plurality of datastreams being correctly directed to one or more of the plurality of components. The system may retrieve a first embedding table, which encodes respective weights representing the probabilities of routing tokens from various datastreams to specific components, by querying or accessing the table stored in its memory or database during the routing process. This embedding table is typically a pre-trained or dynamically updated 2D matrix where each row corresponds to a datastream or token type, and each column corresponds to a component in the network model. Each cell in the table contains a weight that reflects the learned probability of successfully routing a token from a specific datastream to a particular component. These weights are determined during a training phase where the system optimizes the table based on historical data and task-specific objectives, such as maximizing accuracy or efficiency in processing.

When a token is received from a datastream, the system may use metadata or an identifier associated with the datastream to locate its corresponding row in the embedding table. The retrieved row provides a set of weights that indicate the likelihood of each component being suitable for processing the token. This information is then used as input to the system's routing mechanism, such as a bifurcated routing system, to guide the decision-making process. The embedding table enables the system to make informed, probabilistic routing decisions without requiring exhaustive computations or manual rule definitions, ensuring scalability and adaptability to diverse inputs. By continuously updating or fine-tuning the embedding table based on feedback from processing outcomes, the system ensures that the weights remain accurate and reflective of real-world performance. This allows the embedding table to serve as a dynamic and efficient bridge between incoming tokens and the appropriate components in the network, enabling seamless handling of heterogeneous datastreams and optimizing the overall performance of the system.

In some embodiments, the first embedding table is trained by receiving historic token data and training the first embedding table based on the historic token data. For example, the system may train the first embedding table by leveraging historic token data to learn relationships between datastreams, tokens, and components in the network model. The historic token data contains records of past tokens, their characteristics, associated datastreams, and their routing and processing outcomes within the network. The system begins by analyzing this data to identify patterns and correlations, such as which tokens from specific datastreams were successfully processed by certain components or network nodes, and under what conditions. Using this historic data, the system initializes the first embedding table, where each row corresponds to a unique datastream or token type, and each column represents a potential network component. Initially, the embeddings in the table may be set to random values or pre-trained representations. The system then uses a supervised learning approach to train the embeddings, treating the table as a set of trainable weights. For each historic token, the system retrieves its associated datastream or type, locates the corresponding row in the embedding table, and computes predictions for the token's routing or processing using a routing model, such as a neural network. The predicted outcomes are compared to the actual routing or processing results from the historic data, and a loss function, such as cross-entropy loss, is calculated to measure the discrepancy. The system updates the embedding table through backpropagation, adjusting the weights to minimize the loss. This iterative process continues until the embeddings capture the relationships between datastreams, tokens, and components effectively, enabling accurate predictions of routing probabilities and processing outcomes. By training the embedding table on historic token data, the system learns to encode meaningful information about the compatibility and relevance of different components for specific types of tokens. These embeddings allow the system to make data-driven, adaptive routing decisions in real time, improving the efficiency and accuracy of token processing in the network model. Over time, as more historic data becomes available, the system can refine the embedding table further, ensuring that it remains robust and up-to-date with changing patterns in token characteristics and network performance.

At step 406, process 400 (e.g., using one or more components described above) processes, using the first embedding table, the first token in a first router. For example, the system may process, using the first embedding table, the first token in a first router to determine a first probability for a first network node in the first network model being a correct destination node for the first token. For example, the system may process the first token using the first embedding table in a first router to determine the probability of a first network node being the correct destination by leveraging the embedding table's pre-trained or dynamically learned weights. When the first token is received, it is associated with its originating datastream, which maps to a corresponding row in the embedding table. This row contains the embedding values or weights that encode the learned relationships between the datastream and all the potential network nodes in the first network model. These weights represent the probabilities of each network node being a suitable destination for processing tokens of this type.

The first router may use the retrieved embedding values as input to compute a probability distribution over all nodes in the network model. This is typically done by applying a softmax or similar normalization function to the weights, ensuring that the output probabilities sum to one and reflect the relative likelihood of each node being the correct destination. The first router may also incorporate additional contextual information from the token, such as its content or temporal characteristics, to refine the probability calculation.

Based on this computed probability distribution, the first router may identify the likelihood of the first network node being the correct destination for the token. This probability is then used to guide the routing decision, either directly by selecting the node with the highest probability or indirectly by passing the probabilities to a downstream router or decision-making mechanism for further refinement. This probabilistic approach enables the system to dynamically adapt to diverse datastreams and token types while ensuring that routing decisions are data-driven and optimized for the specific characteristics of the network model and task requirements. By continuously updating the embedding table through feedback from processing outcomes, the system maintains accurate and effective routing, even in dynamic or heterogeneous environments.

In some embodiments, the system may process the first token in the first router by determining embeddings from the first embedding table that are used as input features for a probabilistic model into which the first token is inputted and receiving a first output from the probabilistic model. For example, the system may process the first token in the first router by leveraging the first embedding table to derive embeddings that serve as input features for a probabilistic model. When the first token is received, the system identifies its associated datastream or token type, which corresponds to a specific row in the first embedding table. The embedding table encodes a dense, trainable vector representation of each datastream or token type, capturing its characteristics and relationships with potential components in the network model. The system retrieves the appropriate embedding for the token, which encapsulates high-level contextual and semantic information. The retrieved embedding is then combined with other relevant features of the first token, such as additional metadata or contextual attributes, to form a comprehensive input feature vector. This feature vector is passed into the probabilistic model within the first router, which may be a neural network, a softmax function, or another statistical model designed to compute probabilities. The probabilistic model processes the input and evaluates the likelihood of the first token being successfully processed by each of the potential components or nodes in the network model. The system receives a first output from the probabilistic model, which is typically a probability distribution over the components or nodes. Each value in the distribution represents the model's confidence in a particular component being the correct destination for the token. This output serves as the basis for the system's initial routing decision, allowing the token to be directed to a subset of suitable components or nodes in the network for further processing. By using embeddings from the first embedding table as input features, the system ensures that the probabilistic model is informed by learned relationships and contextual insights, enabling adaptive and data-driven routing decisions.

At step 408, process 400 (e.g., using one or more components described above) filters the plurality of components. For example, the system may filter the plurality of components based on whether each of the plurality of components is approved to receive potential tokens from the first datastream to generate a first subset of components. The system may then determine that the first network node corresponds to one or more components in the first subset of components. For example, the system filters the plurality of components to generate a first subset of components approved to receive tokens from the first datastream by applying predefined compatibility constraints or dynamic rules during the routing process. When a token from the first datastream is received, the system references metadata or policies associated with the datastream and each component in the network model. These policies define whether a given component is equipped or authorized to process tokens from that specific datastream based on factors such as data type, task alignment, or processing capabilities. The system evaluates each component against these criteria and filters out those that do not meet the requirements, leaving a subset of components that are explicitly approved to handle tokens from the first datastream.

Once this filtering step is complete, the system may use the first embedding table and the first router to further refine the selection process within the approved subset. The router calculates probabilities for each component in the subset, indicating the likelihood of successfully processing the token. The probabilities are computed using the embedding values corresponding to the first datastream, ensuring that the decision is informed by both learned relationships and contextual features of the datastream. From these probabilities, the system identifies the most suitable component within the subset, confirming that the first network node corresponds to one or more components in this filtered subset. By combining filtering and probabilistic routing, the system ensures that tokens are directed only to compatible and capable components while maintaining flexibility to dynamically adapt to varying input characteristics and system conditions. This two-stage process of filtering and routing helps prevent misallocations, optimize resource utilization, and enhance the accuracy and efficiency of token processing in the network model.

In some embodiments, the system may filter the plurality of components based on whether each of the plurality of components is approved to receive potential tokens from the first datastream to generate the first subset of components by determining a respective data format for each of the plurality of datastreams and determining whether each of the plurality of components is compatible with the respective data format. For example, the system may filter the plurality of components to generate a first subset of components by evaluating whether each component is approved to receive potential tokens from the first datastream. This filtering process begins by determining the respective data format for the first datastream, which describes the structure, type, or characteristics of the data it produces. For example, the data format may specify whether the datastream contains numerical values, text, images, audio, or a combination of modalities, along with details such as dimensionality, encoding, or file structure. The system then assesses each component in the network model to determine whether it is compatible with the identified data format of the first datastream. Compatibility is established based on predefined metadata or specifications associated with each component, such as the types of data the component is designed to process, its input requirements, and its ability to handle specific formats or modalities. For instance, a component specializing in image recognition would be compatible with image datastreams but not with textual data, while a natural language processing module would only process text tokens. Using these compatibility checks, the system filters out components that cannot handle the data format of the first datastream, leaving only those that are approved and capable of processing tokens from this datastream. This filtered group of components forms the first subset of components, which serves as the basis for the next stages of the routing process. By ensuring that only compatible components are included in the subset, the system prevents errors, optimizes resource allocation, and streamlines routing decisions, allowing tokens to be directed efficiently and accurately to appropriate destinations. This approach is particularly effective in handling heterogeneous datastreams in complex, multi-component network models.

In some embodiments, the system may filter the plurality of components based on whether each of the plurality of components is approved to receive potential tokens from the first datastream to generate the first subset of components by determining a respective processing load for each of the plurality of datastreams and determining whether each of the plurality of components is available for the respective processing load. For example, the system filters the plurality of components to generate a first subset of components approved to receive potential tokens from the first datastream by evaluating the processing load associated with the datastream and the availability of each component to handle that load. This process begins by determining the respective processing load for the first datastream, which includes factors such as the computational resources required to process tokens from the datastream, the frequency or rate of token arrivals, and the complexity of the operations needed. For example, a datastream producing high-resolution images may have a significantly higher processing load compared to a text datastream with simple keyword extraction tasks. Next, the system assesses the current state and capacity of each component in the network model to determine whether it is available to handle the processing load of the first datastream. Each component has associated metadata or real-time monitoring metrics that indicate its workload, resource usage (e.g., CPU, GPU, memory), and queue lengths. The system evaluates whether the component has sufficient available resources to accommodate the additional load from the first datastream without causing delays or performance degradation. Components operating near their maximum capacity or those already dedicated to high-priority tasks may be excluded from the list of eligible components. Based on this evaluation, the system filters out components that are either incompatible with the processing load of the first datastream or unavailable due to resource constraints. The remaining components, which are both capable and available to process tokens from the datastream, form the first subset of components. By considering processing load and component availability, the system ensures efficient allocation of resources, avoids overloading components, and maintains optimal performance for the network model. This dynamic filtering process is particularly valuable in environments with fluctuating workloads and heterogeneous inputs, enabling adaptive and reliable routing decisions.

In some embodiments, the system may filter the plurality of components based on whether each of the plurality of components is approved to receive potential tokens from the first datastream to generate the first subset of components by determining a respective processing time requirement for each of the plurality of datastreams and determining whether each of the plurality of components is corresponds to the respective processing time requirement. For example, the system may filter the plurality of components to generate the first subset of components approved to receive potential tokens from the first datastream by evaluating the processing time requirement associated with the datastream and matching it to the capabilities of each component in the network model. This process begins by determining the respective processing time requirement for the first datastream, which includes the time-sensitive nature of processing tokens from the datastream. For example, real-time datastreams, such as live video feeds or financial transaction logs, may have strict latency constraints, while batch-processed datastreams, like large datasets for offline analysis, may have more relaxed time requirements. Once the processing time requirement for the datastream is identified, the system evaluates each component in the network model to determine whether it can meet this requirement. This involves checking the component's processing speed, latency characteristics, and current workload. Each component is associated with metadata or real-time performance metrics that indicate its expected response time under various conditions. For instance, components designed for high-throughput, low-latency tasks are suitable for datastreams with stringent time constraints, while components optimized for accuracy or complex processing may be better suited for tasks with longer allowable processing times. The system compares the datastream's processing time requirement with the capabilities of each component. Components that cannot process tokens from the first datastream within the required timeframe are filtered out, leaving only those that can meet the timing constraints. The remaining components form the first subset of components, ensuring that tokens from the datastream are routed to components capable of handling them within the specified time limits. By integrating processing time requirements into the filtering process, the system ensures that routing decisions respect the temporal constraints of each datastream. This prevents delays in time-sensitive applications and optimizes resource utilization by matching components to tasks they can handle effectively. Such a time-aware filtering mechanism is crucial for maintaining performance in environments with diverse datastreams and varied latency requirements.

In some embodiments, the system may filter the plurality of components based on whether each of the plurality of components is approved to receive potential tokens from the first datastream to generate the first subset of components by determining a respective data complexity of data in each of the plurality of datastreams and determining whether each of the plurality of components is available for processing the data of with the respective data complexity. For example, the system may filter the plurality of components to generate a first subset of components approved to receive potential tokens from the first datastream by evaluating the data complexity of the datastream and matching it with the processing capabilities of each component in the network model. The process begins with determining the respective data complexity of the data in the first datastream, which may include factors such as the size, dimensionality, structure, or inherent difficulty of processing the data. For example, high-dimensional data like 3D images or complex graphs requires significantly more computational resources and sophisticated algorithms compared to simpler, low-dimensional data like scalar sensor readings or basic numerical values. Next, the system assesses the processing capabilities of each component to determine its ability to handle data with the identified complexity. Each component is associated with metadata that describes its specialization, computational power, and algorithmic suitability for different types of data complexity. For instance, components equipped with advanced neural networks or GPU acceleration may be suited for highly complex data, while simpler components optimized for lightweight operations may handle less complex data more efficiently. Additionally, the system evaluates the current availability of each component, considering factors such as resource usage and workload. The system compares the data complexity of the first datastream with the processing capabilities and availability of each component. Components that lack the necessary computational resources or algorithmic capacity to process the data from the datastream are filtered out, as are components that are unavailable due to high workloads or conflicting tasks. The remaining components, which are both capable of handling the data complexity and available for processing, form the first subset of components. By incorporating data complexity into the filtering process, the system ensures that tokens from the first datastream are routed to components that can effectively process them without bottlenecks or performance degradation. This approach optimizes resource allocation and prevents mismatches between data characteristics and component capabilities, enabling the system to handle diverse and complex datastreams dynamically and efficiently.

At step 410, process 400 (e.g., using one or more components described above) processes the first token in a second router. For example, the system may, in response to determining that the first network node corresponds to the one or more components in the first subset of components, process the first token in a second router to determine a second probability for the first network node in the first network model being the correct destination node for the first token. For example, in response to determining that the first network node corresponds to one or more components in the first subset of components, the system processes the first token in a second router to refine the routing decision by calculating a second probability for the first network node being the correct destination. This process begins with the output of the first router, which has already filtered the plurality of components to generate the subset approved to handle tokens from the first datastream. The second router then uses the first token's embedding, additional contextual features, and the restricted set of potential components to perform a more detailed evaluation.

The second router may apply a probabilistic model or function tailored for fine-grained decision-making. It considers factors such as the token's specific attributes, the current state of the network, and the processing capabilities or workload of the components within the subset. Using this information, the second router calculates a refined probability distribution over the components in the subset, focusing on their suitability as the destination node for the token. This step might involve additional layers of computation, such as analyzing temporal dependencies, task-specific requirements, or real-time feedback from the system.

The second probability for the first network node is derived from this refined distribution, representing the likelihood of it being the optimal destination for the token within the restricted context of the approved subset. By narrowing the scope and leveraging more granular information, the second router ensures that the final routing decision is both accurate and efficient. This hierarchical approach, where the first router provides a broad-level filtering and the second router performs detailed evaluation, allows the system to handle complex routing scenarios dynamically while maintaining high performance and reliability.

At step 412, process 400 (e.g., using one or more components described above) directs the first token to the first network node. For example, the system may direct the first token to the first network node based on the first probability and the second probability. For example, the system combines the insights from both probabilities—using the first probability to broadly narrow the scope and the second probability to finalize the decision—to direct the token to the first network node. This hierarchical routing decision might involve a weighted combination of the two probabilities or rely entirely on the refined output of the second router, depending on the system's design and objectives. Once the first network node is determined as the most probable and suitable destination, the system routes the token to that node for processing. This approach ensures that the routing process is both efficient and precise, leveraging global and local context to optimize performance across the network model.

In some embodiments, the system may direct the first token to the first network node based on the first probability and the second probability by determining a first aggregated probability for the first network node and comparing the first aggregated probability to a threshold probability to determine whether to direct the first token to the first network node. For example, the system may system directs the first token to the first network node by combining the first probability, computed by the first router, and the second probability, refined by the second router, into an aggregated measure that reflects the overall likelihood of the first network node being the correct destination. The system calculates the first aggregated probability by applying a mathematical operation, such as a weighted average, product, or other aggregation function, to integrate the two probabilities. This aggregated probability captures both the high-level suitability determined by the first router and the fine-grained evaluation provided by the second router, ensuring a comprehensive assessment of the node's relevance for processing the token. Once the first aggregated probability is determined, the system compares it to a predefined threshold probability. The threshold acts as a decision boundary, representing the minimum confidence required to route the token to the network node. If the aggregated probability for the first network node meets or exceeds the threshold, the system concludes that the node is a suitable destination and directs the token to it. If the probability falls below the threshold, the system may either reroute the token to a different node with a higher aggregated probability or take alternative actions, such as flagging the token for further evaluation. This approach ensures that routing decisions are both data-driven and robust, leveraging multiple levels of probability assessment to minimize errors and optimize performance. By incorporating the threshold mechanism, the system can balance precision and flexibility, ensuring that only tokens with a sufficiently high likelihood of successful processing are directed to the chosen node. This process is particularly effective in dynamic and heterogeneous environments, where accurate routing is critical for maintaining efficiency and system reliability.

In some embodiments, the system may direct the first token to the first network node based on the first probability and the second probability by determining a first aggregated probability for the first network node and comparing the first aggregated probability to a second aggregated probability for a second network node to determine whether to direct the first token to the first network node. For example, the system directs the first token to the first network node by leveraging both the first probability, computed by the first router, and the second probability, refined by the second router, to calculate an aggregated probability for each potential destination node. The first aggregated probability for the first network node is determined by combining the first and second probabilities using a mathematical operation, such as a weighted sum, product, or another aggregation function. This value represents the overall likelihood of the first network node being the most suitable destination for the token, taking into account both high-level routing information and detailed contextual analysis. Simultaneously, the system calculates a second aggregated probability for the second network node using the same method, ensuring that the probabilities for all potential nodes in the filtered subset are evaluated consistently. The system then compares the first aggregated probability with the second aggregated probability (and potentially with aggregated probabilities for additional nodes, if applicable). The comparison identifies the node with the highest aggregated probability, which reflects the greatest likelihood of correctly processing the token. If the first aggregated probability is greater than or equal to the second aggregated probability, the system determines that the first network node is the optimal destination and directs the token to it. If the second aggregated probability is higher, the token is routed instead to the second network node. By making this decision based on comparative aggregated probabilities, the system ensures that the token is directed to the most appropriate node for processing, optimizing for both accuracy and efficiency. This approach dynamically adapts to the characteristics of the token and the network model, enabling precise and context-aware routing in complex, multi-node systems.

In some embodiments, the system may direct the first token to the first network node based on the first probability and the second probability by processing the first token with a first component of the plurality of components, wherein the first network node corresponds to the first component, generating a first output from the first component, generating a second token for further processing in the first network model, and directing the second token to a second network node in the first network model. For example, the system may direct the first token to the first network node by processing it through a multi-step workflow that integrates initial routing, component-based processing, and subsequent routing decisions. The process begins with the system using the first probability, determined by the first router, and the second probability, refined by the second router, to decide that the first token should be routed to the first network node. This node corresponds to a specific component in the network model that is deemed most suitable for handling the token based on its characteristics and the context provided by the probabilities. Once the first token reaches the first component, the system processes it according to the specialized functionality of that component. This processing step may involve performing a task such as feature extraction, transformation, classification, or analysis, depending on the purpose of the first component. The result of this processing is a first output, which represents the intermediate data or results generated by the first component. Using the first output, the system generates a second token to encapsulate the updated information derived from the processing. This second token may carry enhanced features, contextual information, or refined representations, making it ready for further processing in the network model. The generation of the second token ensures continuity and adaptability in the system, allowing the network model to handle complex, multi-stage workflows effectively. The second token is then routed to a second network node in the first network model for additional processing. The system determines the destination for the second token using a similar decision-making process, where routers evaluate the updated token and assign it to the most appropriate component or node. This iterative approach allows the system to dynamically direct tokens through multiple layers or pathways within the network model, optimizing for accuracy, efficiency, and specialization at each stage of processing. By linking the first token's routing and processing with the generation and routing of subsequent tokens, the system achieves seamless and adaptive handling of complex inputs in the network model.

In some embodiments, the system may direct the first token to the first network node based on the first probability and the second probability by determining a first component of the plurality of components for processing the first token and processing the first token with the first component at the first network node. For example, the system may direct the first token to the first network node by first using the first probability, calculated by the first router, and the second probability, refined by the second router, to determine the most suitable component for processing the token. These probabilities reflect the likelihood of various components in the network model being optimal for handling the token based on its characteristics and context. The system evaluates all potential components and selects the first component as the one most appropriate for processing the token. This decision takes into account factors such as the token's datastream type, the component's specialization, and its compatibility with the token's processing requirements. Once the first component is identified, the system routes the token to the first network node, which corresponds to the selected component. At the network node, the first component processes the token according to its specific functionality. This processing step may involve applying machine learning algorithms, performing data transformations, or executing task-specific computations tailored to the token's attributes and the goals of the system. For example, if the token represents textual data, the first component at the network node might perform sentiment analysis or named entity recognition. By directly linking the token to the first component at the first network node, the system ensures that the processing is both targeted and efficient, leveraging the specialized capabilities of the selected component to achieve optimal results. This approach integrates probabilistic routing with dynamic task assignment, enabling the system to adaptively handle diverse inputs while maintaining high performance and accuracy. After processing, the token's state may be updated for further routing or finalized, depending on the system's overall workflow and objectives.

In some embodiments, the system may direct the first token to the first network node based on the first probability and the second probability by determining a first component of the plurality of components for processing the first token and processing the first token with the first component at the first network node. For example, the system may direct the first token to the first network node by utilizing the first probability, calculated by the first router, and the second probability, refined by the second router, to identify the most suitable component for processing the token. These probabilities represent the system's confidence in various components being the correct destination for the token based on its characteristics and context. The system evaluates these probabilities across the available components and determines that the first component, located at the first network node, is the most appropriate choice for processing the token. After selecting the first component, the system routes the token to the first network node, which corresponds to the identified component in the network model. At the network node, the first component processes the token according to its specialized functionality. This processing might involve applying a specific algorithm, transforming the data, or extracting relevant features depending on the type of token and the component's role. For instance, if the token represents a sensor reading, the first component could apply anomaly detection; if it is text data, the component might perform text classification or summarization. This routing and processing flow ensures that the token is handled by the most capable and relevant component, optimizing both system efficiency and accuracy. By integrating the first and second probabilities into the decision-making process, the system balances high-level routing with detailed, context-sensitive refinement. This approach enables adaptive and precise handling of diverse tokens in complex network models, ensuring that resources are utilized effectively and that processing aligns with the system's objectives. After processing, the system may update the token for further routing or use the results for downstream tasks, depending on the overall workflow.

In some embodiments, the system may direct the first token to the first network node based on the first probability and the second probability by determining a first network layer of the first network model corresponding to the first network node and processing the first token at the first network layer. For example, the system may direct the first token to the first network node by leveraging the first probability, calculated by the first router, and the second probability, refined by the second router, to determine the most appropriate network layer within the first network model for processing the token. These probabilities reflect the system's assessment of the suitability of various network layers and nodes for handling the token, considering both high-level characteristics and detailed contextual information. Based on this assessment, the system identifies the first network layer, which corresponds to the first network node, as the optimal layer for processing the token. Once the first network layer is determined, the system routes the token to the first network node within that layer. At the layer, the token is processed using the operations or transformations specific to that layer, such as feature extraction, activation functions, or task-specific computations. For example, in a deep learning model, the first network layer might perform initial processing steps like convolution in a convolutional neural network (CNN) or token embedding in a transformer model. These operations prepare the token for deeper processing in subsequent layers, ensuring that its characteristics are appropriately encoded or transformed. By aligning the routing decision with the specific capabilities of the first network layer, the system ensures that the token is processed in a manner that maximizes both efficiency and accuracy. The use of first and second probabilities allows the system to balance high-level routing logic with detailed, context-aware refinements, ensuring that the token is directed to the most suitable layer for its processing requirements. After processing at the first network layer, the token may be passed to subsequent layers or components in the network model, depending on the overall system workflow and the nature of the task. This hierarchical and adaptive approach enables the system to handle complex inputs dynamically while maintaining robust performance.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for network routing from heterogenous datastreams to different network components.

2. The method of the preceding embodiments, further comprising: receiving, from a first datastream of a plurality of datastreams, a first token for processing in a first network model, wherein the first network model comprises a plurality of components, and wherein each component corresponds to a respective network node in the first network model; retrieving a first embedding table, wherein the first embedding table comprises respective weights indicating respective probabilities of any potential token received from each of the plurality of datastreams being correctly directed to one or more of the plurality of components; processing, using the first embedding table, the first token in a first router to determine a first probability for a first network node in the first network model being a correct destination node for the first token, wherein the first probability; filtering the plurality of components based on whether each of the plurality of components is approved to receive potential tokens from the first datastream to generate a first subset of components; determining that the first network node corresponds to one or more components in the first subset of components; in response to determining that the first network node corresponds to the one or more components in the first subset of components, processing the first token in a second router to determine a second probability for the first network node in the first network model being the correct destination node for the first token; and directing the first token to the first network node based on the first probability and the second probability.

3. The method of any one of the preceding embodiments, wherein receiving the first token further comprises: receiving a first event for processing in the first network model; and generating the first token based on the first event by grouping sequences of multimodal inputs in the first event.

4. The method of any one of the preceding embodiments, wherein receiving the first token further comprises: receiving a first event for processing in the first network model; determining an event type for the first event; and generating the first token based on the event type.

5. The method of any one of the preceding embodiments, wherein receiving the first token further comprises: receiving a first event for processing in the first network model; determining a text string in the first event; and generating the first token based on applying parts-of-speech tagging to the text string.

6. The method of any one of the preceding embodiments, wherein receiving the first token further comprises: receiving a first event sequence in the first datastream; detecting a first pattern in the first event sequence; determining a first event in the first event sequence based on the first pattern; and generating the first token based on first event.

7. The method of any one of the preceding embodiments, wherein directing the first token to the first network node based on the first probability and the second probability further comprises: determining a first aggregated probability for the first network node; and comparing the first aggregated probability to a threshold probability to determine whether to direct the first token to the first network node.

8. The method of any one of the preceding embodiments, wherein directing the first token to the first network node based on the first probability and the second probability further comprises: determining a first aggregated probability for the first network node; and comparing the first aggregated probability to a second aggregated probability for a second network node to determine whether to direct the first token to the first network node.

9. The method of any one of the preceding embodiments, wherein directing the first token to the first network node based on the first probability and the second probability further comprises: processing the first token with a first component of the plurality of components, wherein the first network node corresponds to the first component; generating a first output from the first component; generating a second token for further processing in the first network model; and directing the second token to a second network node in the first network model.

10. The method of any one of the preceding embodiments, wherein directing the first token to the first network node based on the first probability and the second probability further comprises: determining a first component of the plurality of components for processing the first token; and processing the first token with the first component at the first network node.

11. The method of any one of the preceding embodiments, wherein directing the first token to the first network node based on the first probability and the second probability further comprises: determining a first network layer of the first network model corresponding to the first network node; and processing the first token at the first network layer.

12. The method of any one of the preceding embodiments, wherein the first embedding table is trained by: receiving historic token data; and training the first embedding table based on the historic token data.

13. The method of any one of the preceding embodiments, wherein processing the first token in the first router further comprises: determining embeddings from the first embedding table that are used as input features for a probabilistic model into which the first token is inputted; and receiving a first output from the probabilistic model.

14. The method of any one of the preceding embodiments, wherein filtering the plurality of components based on whether each of the plurality of components is approved to receive potential tokens from the first datastream to generate the first subset of components further comprises: determining a respective data format for each of the plurality of datastreams; and determining whether each of the plurality of components is compatible with the respective data format.

15. The method of any one of the preceding embodiments, wherein filtering the plurality of components based on whether each of the plurality of components is approved to receive potential tokens from the first datastream to generate the first subset of components further comprises: determining a respective processing load for each of the plurality of datastreams; and determining whether each of the plurality of components is available for the respective processing load.

16. The method of any one of the preceding embodiments, wherein filtering the plurality of components based on whether each of the plurality of components is approved to receive potential tokens from the first datastream to generate the first subset of components further comprises: determining a respective processing time requirement for each of the plurality of datastreams; and determining whether each of the plurality of components is corresponds to the respective processing time requirement.

17. The method of any one of the preceding embodiments, wherein filtering the plurality of components based on whether each of the plurality of components is approved to receive potential tokens from the first datastream to generate the first subset of components further comprises: determining a respective data complexity of data in each of the plurality of datastreams; and determining whether each of the plurality of components is available for processing the data of with the respective data complexity.

18. One or more non-transitory, computer-readable mediums storing instructions that, when executed by a data processing apparatus, cause the data processing apparatus to perform operations comprising those of any of embodiments 1-17.

19. A system comprising one or more processors; and memory storing instructions that, when executed by the processors, cause the processors to effectuate operations comprising those of any of embodiments 1-17.

20. A system comprising means for performing any of embodiments 1-17.

What is claimed is:

1. A system for network routing of different events from heterogenous datastreams to different network components, the system comprising:
one or more processors; and
one or more non-transitory, computer-readable mediums comprising instructions recorded thereon that when executed by the one or more processors cause operations comprising:
receiving, from a first multimodal datastream of a plurality of multimodal datastreams, a first event for processing in a first network model, wherein the first network model comprises a plurality of computer network components, and wherein each computer network component corresponds to a respective network node in the first network model;
generating a first token based on the first event by grouping sequences of multimodal inputs in the first event;
retrieving a first embedding table, wherein the first embedding table comprises respective weights indicating respective probabilities of any potential token received from each of the plurality of multimodal datastreams being correctly directed to one or more of the plurality of computer network components;
processing the first token in a first router to determine a first probability for a first network node, corresponding to a first computer network component of the plurality of computer network components, in the first network model being a correct destination node for the first token, wherein the first probability is based on the respective weights in the first embedding table;
filtering the plurality of computer network components based on whether each of the plurality of computer network components is approved to receive potential tokens from the first multimodal datastream to generate a first subset of computer network components;
determining that the first network node corresponds to one or more computer network components in the first subset of computer network components;
in response to determining that the first network node corresponds to the one or more computer network components in the first subset of computer network components, processing the first token in a second router to determine a second probability for the first network node in the first network model being the correct destination node for the first token; and
directing the first token to the first network node based on the first probability and the second probability.

2. A method for network routing from heterogenous datastreams to different network components, the method comprising:
retrieving a first embedding table, wherein the first embedding table comprises respective weights indicating respective probabilities of any potential token received from each of a plurality of datastreams being correctly directed to one or more of a plurality of components;
processing, using the first embedding table, a first token in a first router to determine a first probability for a first network node in a first network model being a correct destination node for the first token;
filtering the plurality of components based on whether each of the plurality of components is approved to receive potential tokens from a first datastream of the plurality of datastreams to generate a first subset of components;
determining that the first network node corresponds to one or more components in the first subset of components;
in response to determining that the first network node corresponds to the one or more components in the first subset of components, processing the first token in a second router to determine a second probability for the first network node in the first network model being the correct destination node for the first token; and
directing the first token to the first network node based on the first probability and the second probability.

3. The method of claim 2, wherein receiving the first token further comprises:
receiving a first event for processing in the first network model; and
generating the first token based on the first event by grouping sequences of multimodal inputs in the first event.

4. The method of claim 2, wherein receiving the first token further comprises:
receiving a first event for processing in the first network model;
determining an event type for the first event; and
generating the first token based on the event type.

5. The method of claim 2, wherein receiving the first token further comprises:
receiving a first event for processing in the first network model;
determining a text string in the first event; and
generating the first token based on applying parts-of-speech tagging to the text string.

6. The method of claim 2, wherein receiving the first token further comprises:
receiving a first event sequence in the first datastream;
detecting a first pattern in the first event sequence;
determining a first event in the first event sequence based on the first pattern; and
generating the first token based on first event.

7. The method of claim 2, wherein directing the first token to the first network node based on the first probability and the second probability further comprises:
determining a first aggregated probability for the first network node; and
comparing the first aggregated probability to a threshold probability to determine whether to direct the first token to the first network node.

8. The method of claim 2, wherein directing the first token to the first network node based on the first probability and the second probability further comprises:
determining a first aggregated probability for the first network node; and
comparing the first aggregated probability to a second aggregated probability for a second network node to determine whether to direct the first token to the first network node.

9. The method of claim 2, wherein directing the first token to the first network node based on the first probability and the second probability further comprises:
processing the first token with a first component of the plurality of components, wherein the first network node corresponds to the first component;
generating a first output from the first component;
generating a second token for further processing in the first network model; and
directing the second token to a second network node in the first network model.

10. The method of claim 2, wherein directing the first token to the first network node based on the first probability and the second probability further comprises:
determining a first component of the plurality of components for processing the first token; and
processing the first token with the first component at the first network node.

11. The method of claim 2, wherein directing the first token to the first network node based on the first probability and the second probability further comprises:
determining a first network layer of the first network model corresponding to the first network node; and
processing the first token at the first network layer.

12. The method of claim 2, wherein the first embedding table is trained by:
receiving historic token data; and
training the first embedding table based on the historic token data.

13. The method of claim 2, wherein processing the first token in the first router further comprises:
determining embeddings from the first embedding table that are used as input features for a probabilistic model into which the first token is inputted; and
receiving a first output from the probabilistic model.

14. The method of claim 2, wherein filtering the plurality of components based on whether each of the plurality of components is approved to receive potential tokens from the first datastream to generate the first subset of components further comprises:
determining a respective data format for each of the plurality of datastreams; and
determining whether each of the plurality of components is compatible with the respective data format.

15. The method of claim 2, wherein filtering the plurality of components based on whether each of the plurality of components is approved to receive potential tokens from the first datastream to generate the first subset of components further comprises:
determining a respective processing load for each of the plurality of datastreams; and
determining whether each of the plurality of components is available for the respective processing load.

16. The method of claim 2, wherein filtering the plurality of components based on whether each of the plurality of components is approved to receive potential tokens from the first datastream to generate the first subset of components further comprises:
determining a respective processing time requirement for each of the plurality of datastreams; and
determining whether each of the plurality of components is corresponds to the respective processing time requirement.

17. The method of claim 2, wherein filtering the plurality of components based on whether each of the plurality of components is approved to receive potential tokens from the first datastream to generate the first subset of components further comprises:
determining a respective data complexity of data in each of the plurality of datastreams; and
determining whether each of the plurality of components is available for processing the data of with the respective data complexity.

18. One or more non-transitory, computer-readable mediums, comprising instructions that, when executed by one or more processors, cause operations comprising:
receiving, from a first datastream of a plurality of datastreams, a first token for processing in a first network model;
retrieving a first embedding table, wherein the first embedding table comprises respective weights indicating respective probabilities of any potential token received from each of the plurality of datastreams being correctly directed to one or more of a plurality of components;
processing, using the first embedding table, the first token in a first router to determine a first network node in the first network model for the first token;
determining that the first network node corresponds to one or more components in a first subset of components approved to receive potential tokens from the first datastream;
processing the first token in a second router to confirm the first network node for the first token; and
directing the first token to the first network node.

19. The one or more non-transitory, computer-readable mediums of claim 18, wherein receiving the first token further comprises:
receiving a first event for processing in the first network model; and
generating the first token based on the first event by grouping sequences of multimodal inputs in the first event.

20. The one or more non-transitory, computer-readable mediums of claim 18, wherein receiving the first token further comprises:
receiving a first event for processing in the first network model;
determining an event type for the first event; and
generating the first token based on the event type.
